(19) United States
(12) Patent Application Publication
(10) Pub. No.: US 2018/0011181 A1
(43) Pub. Date: Jan. 11, 2018

(54) RADAR SYSTEMS AND METHODS THEREOF

(71) Applicant: Infineon Technologies AG, Neubiberg (DE)

(72) Inventors: Tatsuya Urakawa, Kawasaki-shi (JP); Abhiram Chakraborty, Unterhaching (DE); Masanobu Higuchi, Kawasaki-shi (JP)

(21) Appl. No.: 15/204,603

(22) Filed: Jul. 7, 2016

(51) Int. Cl. G01S 13/40; G01S 7/35; G01S 13/34

(52) U.S. Cl. CPC G01S 13/40; G01S 13/341; G01S 7/352; G01S 2007/356

(57) ABSTRACT

A radar system includes a radar transceiver device, which includes a transmitter front end circuit for transmitting a chirp signal towards an object. The radar transceiver device includes a receiver front end circuit for receiving the reflected chirp signal from the object. The radar transceiver device includes a voltage controlled oscillator (VCO) to generate a transmitted chirp signal. The radar transceiver device includes a mixer configured to generate four intermediate frequency output signals having different phases. The radar system includes a controller device, which includes a processor, and a memory for storing the intermediate frequency output signals and instructions for executing in the processor. The instructions cause the processor to generate a complex Fast Fourier Transform (FFT) result by performing a FFT of the intermediate frequency output signals while using zero-padding. The instructions cause the processor to determine, using interpolation, a maximum amplitude in the FFT result and identifying the frequency corresponding to the maximum amplitude. The instructions cause the processor to calculate a distance to the object using the determined frequency.

### TECHNICAL FIELD

The present invention relates generally to radar, and, in particular embodiments, to radar system and methods thereof.

### BACKGROUND

Frequency modulated continuous wave (FMCW) microwave radar systems are used in many applications such as automotive applications, for example, for driver assistance, cruise control, active safety applications. In such applications, the FMCW radar system may help to detect objects located around the vehicle, for example. The speed or distance of an object located around the vehicle on which the radar is mounted may be obtained.

A radar transmits or emits signals that are reflected by the object being detected. The reflected signal is processed along with the transmitted signal to obtain the distance to the object. Ordinary pulsed radar detects the range to a target by emitting a short pulse and observing the time of flight of the target echo. However, this requires the radar to have high instantaneous transmit power and often results in a radar with a large, expensive physical apparatus. On the other hand, frequency-modulated continuous-wave radars achieve similar results using much smaller instantaneous transmit powers and physical size by continuously emitting periodic pulses whose frequency content varies with time. Linear FM sweep is a type of FMCW radar pulse with many distinctions. In this case, the range to the target is found by detecting the frequency difference between the received and emitted radar signals. The range to the target is proportional to this frequency difference, which is also referred to as the beat frequency.

In particular, as illustrated in FIG. 1, a microwave antenna transmits a transmitting signal having a varying frequency, i.e., a chirp signal. The transmitting signal has a varying frequency, which enables to determine the time taken for that frequency to return back to the receiver. In an example embodiment, the transmitting signal has a rising slope. A plurality of such pulses may be transmitted.

The received signal is shifted corresponding to a distance from the microwave antenna to the object. The received signal is shifted as illustrated by the dashed line. This time shift generates a beat frequency (called fb) which corresponds to a distance between the antenna and the object. We can get distance information from the beat frequency, and this modulation scheme is called FMCW (Frequency Modulated Continuous Wave). Using FMCW modulation, a microwave radar system can be used as a distance measurement sensor. At the radar system, the distance from the object can be calculated from the beat frequency (fb), the change in frequency (ΔF), and the change in time (ΔT) using the following equations.

$$\frac{fb}{τ} = \frac{Δ F}{Δ T }$$

$$τ = \frac{2 R}{c} \\ ∴ R = \frac{Δ T}{Δ F} \times \frac{fb \times c}{2}$$

In the above equations, fb is the beat frequency, τ is the time shift between the transmitted signal and received signal, R is the distance from microwave antenna to object, and c is the speed of light. The accuracy of distance measurement is given by the formula as follows.

$$Δ R = \frac{c}{2 \times Δ F}$$

In the above equation, ΔR is the accuracy of distance measurement, and ΔF is the frequency bandwidth. Therefore, in order to improve the accuracy of distance measurements using a FMCW radar system, frequency bandwidth of the FMCW radar system has to be expanded. However, the frequency bandwidth is typically restricted due to governmental regulations in most countries. For example, in Japan, the allowed frequency for 24 GHz is between 24.05 GHz to 24.25 GHz resulting in a frequency bandwidth of 200 MHz. Similarly, the allowed frequency for 77 GHz is between 76.0 GHz to 77.0 GHz resulting in a frequency bandwidth of 1 GHz, and the allowed frequency for 79 GHz is between 78.0 GHz to 81.0 GHz resulting in a frequency bandwidth of 3 GHz. These frequency bandwidth result in an accuracy of 75 cm for 24 GHz radar systems, 15 cm for 77 GHz radar systems, and 5 cm for 79 GHz radar systems.

### SUMMARY

In accordance with a preferred embodiment of the present invention, a radar system includes a radar transceiver device, which may include a transmitter front end circuit for transmitting a chirp signal towards an object. The radar transceiver device may include a receiver front end circuit for receiving the reflected chirp signal from the object. The radar transceiver device may include a voltage controlled oscillator (VCO) to generate a transmitted chirp signal. The radar transceiver device may include a mixer configured to generate four intermediate frequency output signals having different phases. The radar system may include a controller device, which includes a processor, and a memory for storing the intermediate frequency output signals and instructions for executing in the processor. The instructions cause the processor to generate a complex Fast Fourier Transform (FFT) result by performing a FFT of the intermediate frequency output signals while using zero-padding. The instructions cause the processor to determine, using interpolation, a maximum amplitude in the FFT result and identifying the frequency corresponding to the maximum amplitude. The instructions cause the processor to calculate a distance to the object using the determined frequency.

Implementations may include one or more of the following features. The transmitter front end circuit of the radar system includes a power amplifier in one embodiment. In one embodiment, the receiver front end circuit of the radar system includes a low noise amplifier. The voltage controlled oscillator of the radar system may be accompanied by a quadrature generator configured to produce a plurality of phase shifted signals. The mixer of the radar system is accompanied by a quadrature generator configured to produce a plurality of phase shifted signals in one embodiment. In an embodiment, the radar system includes four analog to digital converters for converting each of the four intermediate frequency output signals into a corresponding digital signal. The radar system may include a base band amplifier and band pass filter to filter the four intermediate frequency output signals and amplify the filtered four intermediate frequency output signals before the converting. The radar system further includes a first patch antenna coupled to the transmitter front end circuit, and a second patch antenna coupled to the receiver front end circuit. The radar system further includes a plurality of patch antennas coupled to either the transmitter or the receiver front end circuit, or both the transmitter and the receiver front end circuit. The chirp signal utilizes, in one embodiment, the industrial, science, and medical (ISM) band. The radar system is configured to operate between 24.00 GHz to 24.25 GHz in one embodiment.

In an alternative embodiment, a method of estimating of a distance to an object using a radar system includes generating chirp signals at an oscillator from a transmit antenna, transmitting a chirp signal towards an object, and receiving the reflected chirp signal from the object from a receiving antenna. The method includes generating a plurality of phase shifted reference signals from the transmitted chirp signal. The method includes mixing the plurality of phase shifted reference signals with the received reflected chirp signal to generate four intermediate frequency output signals having different phases. The method includes storing the intermediate frequency output signals in a memory. The method includes generating a complex Fast Fourier Transform (FFT) result by performing a FFT on the intermediate frequency output signals while using zero-padding. Using interpolation, a maximum amplitude in the fft result is determined. The frequency corresponding to the maximum amplitude is identified. A distance to the object is calculated using the determined frequency.

Implementations may include one or more of the following features. The chirp signal is generated at a voltage controlled oscillator in one embodiment. The signal generated at the voltage controlled oscillator is amplified at a power amplifier before the transmitting in one embodiment. The received reflected chirp signal at the receive antenna is amplified at a low noise amplifier before the mixing in one embodiment. The method includes converting each of the four intermediate frequency output signals into a corresponding digital signal in one embodiment. The method includes filtering, each of the four intermediate frequency output signals generated by the mixing, at bandpass filter in one embodiment. The method includes amplifying the filtered four intermediate frequency output signals in one embodiment. The transmit antenna includes a first patch antenna and the receive antenna includes a second patch antenna in one embodiment. The transmit antenna and/or receive antenna includes a plurality patch antennas. The chirp signal utilizes industrial, science, and medical (ISM) band. The radar system is configured to operate between 24.00 GHz to 24.25 GHz.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates the principle of operation of a FMCW radar;

FIG. 2 is a schematic of a radar system in accordance with an embodiment of the present invention;

FIG. 3A illustrates a typical FFT of an IF signal performed during processing the IF signal to generate the frequency domain representation of the IF signal;

FIG. 3B illustrates a FFT output after oversampling of an IF signal performed during processing the IF signal to generate the frequency domain representation of the IF signal;

FIG. 3C illustrates a frequency domain representation of the IF signal showing the difference between the results of an unpadded FFT and a FFT performed with zero padding or oversampling.

FIG. 4 is a schematic magnified view of FIG. 3B showing only few frequency bins;

FIG. 5 shows the result of interpolation with unstable amplitude;

FIG. 6A illustrates that the reason for the amplitude instability is due to the varying nature of the envelope IF signal amplitude when only two phases are used;

FIG. 6B, illustrates that the amplitude instability can be significantly reduced by using the four phase signals due to the ability to obtain a much more stable envelope IF signal amplitude than two phase envelope IF signals;

FIG. 7A illustrates the real distance to an object implementing embodiments of the present invention with measurement error for a large reflecting object while FIG. 7B illustrates the real distance to an object implementing embodiments of the present invention with measurement error for a small reflecting object;

FIG. 7C is a table summarizing the results for the large and small reflectors;

FIG. 8A is a radar system illustrating a hardware implementation of the embodiment of the present invention;

FIG. 8B illustrates corresponding schematic steps in the use of the radar system;

FIGS. 9A-9D illustrate an alternative hardware implementation of the embodiment of the present invention, wherein FIG. 9A illustrates a system schematic, FIG. 9B illustrates a magnified schematic of the radar IC, FIG. 9C illustrates a operation cycle of the radar system, and FIG. 9D illustrates operational steps of the radar system; and

FIG. 10 illustrates a package comprising the radar system in accordance with an embodiment of the present invention

### DETAILED DESCRIPTION OF ILLUSTRATIVE EMBODIMENTS

Embodiments of the present invention describe a method and system for improving accuracy of distance measurement by radars. In particular, embodiments of the present invention improve accuracy of radar without taking up a larger frequency bandwidth that would be otherwise required. For example, embodiments of the present invention may be applied to 24 GHz radar systems that are bandwidth limited to 200 MHz in some countries. In case of 24 GHz radar systems that are bandwidth limited to 200 MHz, traditional methods can only provide an accuracy of +/−75 cm. This is because the limited bandwidth reduces the accuracy of distance measurement calculations. Using embodiments of the present invention, much tighter distance measurement can be made without using additional bandwidth. Although explained in the disclosure relative to 24 GHz radar systems, the embodiments of the present invention may be applied to other frequency radar systems such as 77 GHz and 79 GHz.

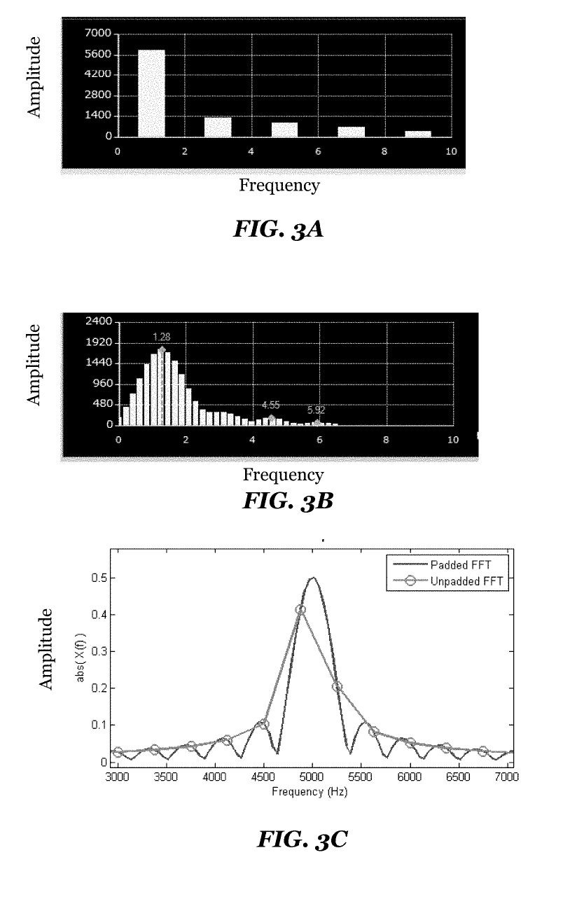

FIG. 2 illustrates an example application for using a radar having a radar system 10. The radar system 10 may be part of an automobile in one example. The radar system 10 transmits and receives, for example, a frequency modulated continuous wave (FMCW) signal, and detects reflections of this transmitted signal in order to determine a distance between radar system 10 and objects around the radar, for example other vehicles on the road. In the illustrated scenario, a large object 61, such as a truck is about the same distance to radar system 10 as a small object 62, such as a motorcycle. Under normal operating conditions, the echo or reflection off large object 61 will have a higher amplitude then the reflection off small object 62 because large object 61 is larger than small object 62. In contrast, when the large object 61 is farther than the smaller object 62, the amplitude of reflected signals from both the objects may be similar. Ideally, the reflectance of the object, which changes the amplitude of the reflected signal, does not change the calculated distance to the object. However, there is a small correlation between the amplitude and the Doppler shift when embodiments of the present invention are used, which will be further described below, due to which the smaller object is perceived to be farther than the larger object even though both are at the same distance.

Embodiments of the present invention overcome these and other errors by using four phase intermediate frequency signals in combination with oversampling and interpolation during FFT processing.

Referring to FIG. 2, a transceiver IC 30 is configured to transmit an incident radio frequency (RF) signal towards the large object 61 via transmit antenna 40 and receive a reflected RF signal via a receive antenna 50. Although only a single antenna is illustrated, the transmit antenna may include multiple transmit antennas to enable a plurality of transmit paths. The antennas may be a patch antenna integrated on a circuit board in one or more embodiments. Similarly, the receive antenna 50 may comprise an antenna array with a plurality of receive paths through multiple antennas. The transceiver IC 30 includes a receiver front end 21 coupled to the receive antenna 50, a transmitter front end 22 coupled to the transmit antenna 40. A radar circuit 23 provides signals to be transmitted to the transmitter front end 22 and also receives and/or processes signals received at the receiver front end 21.

The radar circuit 23 processes the received reflected signal along with the previously transmitted signal to generate intermediate frequency (IF) signals having phase difference of 0°, 90°, 180°, and 270°. In particular, the radar circuit 23 mixes the transmitted signal with the received signal to obtain the intermediate frequency signal.

The phase shifted IF signals are processed at a controller 20, which may comprise digital signal processor (DSP) to determine an accurate estimate of the distance to the large object 61 as well as the small object 62. In various embodiments, a complex FFT of the sum of the four phase shifted intermediate frequency signals is performed using zero padding/oversampling whose results are interpolated to obtain the maximum in the frequency domain, which provides the beat frequency. In various embodiments, in one example, a 24 GHz radar may achieve an accuracy or distance errors less than 3%.

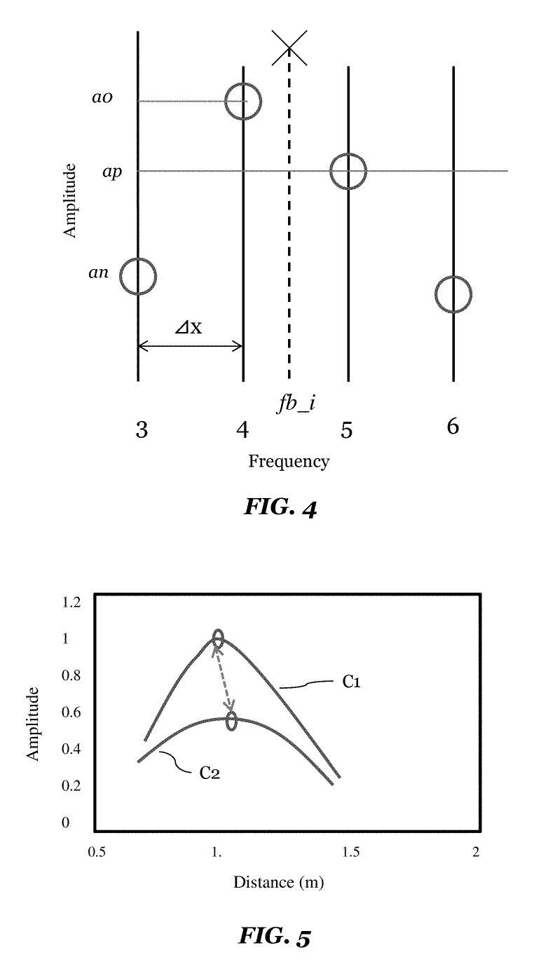

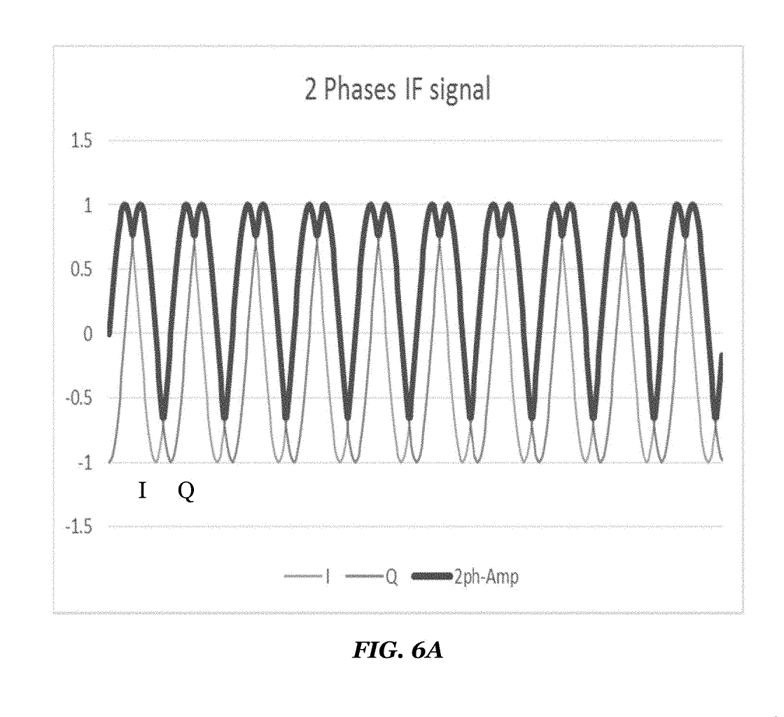

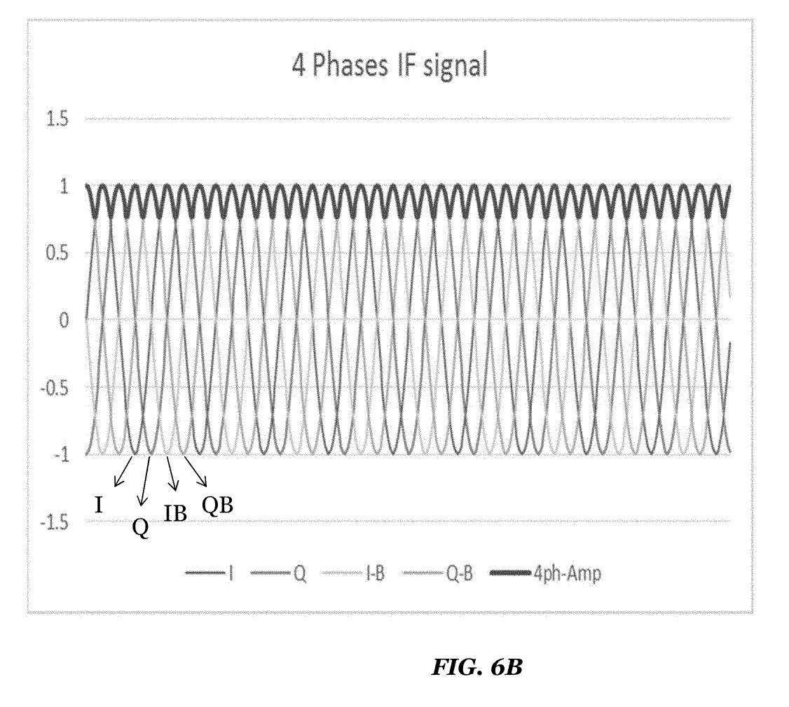

As will be explained in more details using FIGS. 3-7, embodiments of the present invention generate four phase shifted intermediate frequency signals that are subsequently processed with the techniques of oversampling/zero-padding during Fast Fourier Transform (FFT) and followed by an interpolation to determine the beat frequency accurately. The techniques of oversampling during FFT and interpolation will be first described followed by the reasons for the use of the four phase shifted intermediate frequency signals.

FIG. 3A illustrates a typical FFT of an IF signal performed during processing the IF signal to generate the frequency domain representation of the IF signal. FIG. 3B illustrates a FFT output after oversampling of an IF signal performed during processing the IF signal to generate the frequency domain representation of the IF signal. FIG. 3C illustrates a frequency domain representation of the IF signal showing the difference between the unpadded FFT result in which the beat frequency is subject to larger errors while the FFT result with the oversampling shows much better resolution in frequency domain.

As described above, the intermediate frequency signal contains the information corresponding to a distance of the radar from an object. This frequency of the intermediate frequency (IF) signal is also the same as the beat frequency (fb) described previously. The IF signal is observed as a time domain signal so a FFT (Fast Fourier Transform) is performed during the signal processing in order to get the beat frequency from the time domain IF signal.

In a conventional Fast Fourier Transform, the number of actual data points (Nd) that are transformed is the same as the number of sampling points (Ns) in time domain. For example, if the number of actual data points (Nd) is 256, then the number of sampling points (Ns) in time domain is also 256. In various embodiments of the present invention, a zero padding scheme is used to increase the accuracy of the FFT. In particular, the number of sampling points (Ns) in time domain is increased relative to the number of actual data points (Nd), which reduces the FFT bin size. This is also equivalent to adding additional points in the time domain with zero amplitude, i.e., zero values are added to the end of the time domain signal to increase it length. The reduced FFT bin size provides a more accurate estimate of the beat frequency for each IF signal. In other words, the accuracy of distance measurement is improved by a higher number of sampling points. This approach of oversampling or zero padding requires no additional bandwidth extension. The following equation shows the improvement (ΔR′) in accuracy of distance measurement after an oversampled FFT.

$$Δ {R}^{′} = \frac{c}{2 \times Δ F} \times \frac{Nd}{Ns}$$

In the above equation, c is the speed of light, Nd is the number of actual data points that are being transformed, Ns is the total number of sampling points after zero padding.

After oversampling, the accuracy of the FFT output can be further improved by an interpolation technique. In various embodiments, any interpolation technique may be used to obtain the beat frequency as accurately as possible. The interpolation technique is used to interpolate between the highest frequency points so as to obtain a frequency that is better representative of the beat frequency. For example, a linear interpolation may be used in one embodiment.

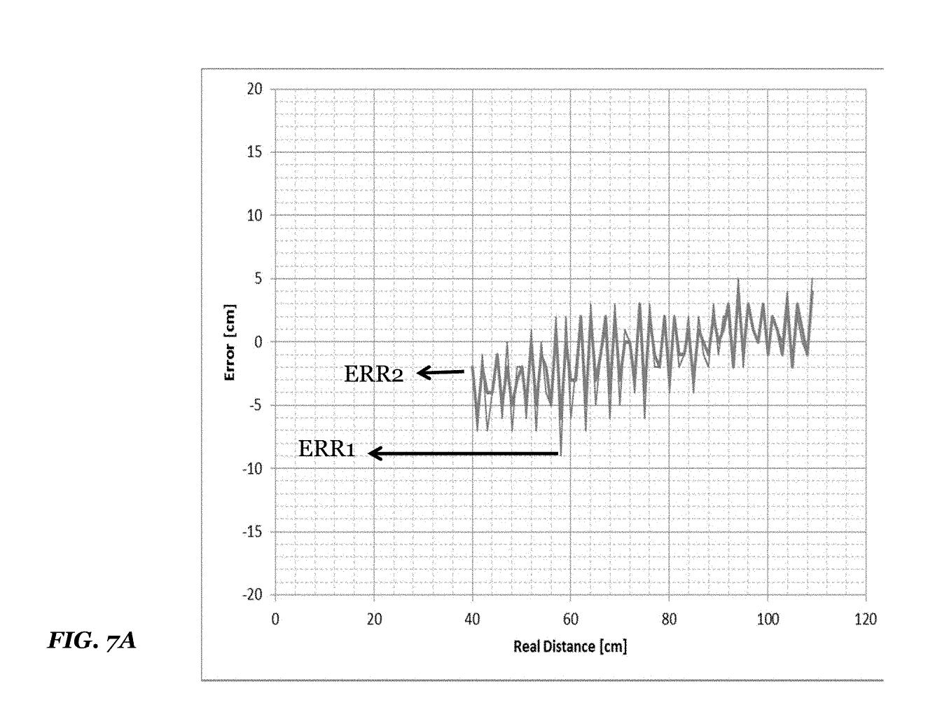

FIG. 4 is a schematic magnified view of FIG. 3B showing only few frequency bins. The distance Δx is the FFT bin or step size. After the interpolation, the interpolated beat frequency fb_i is calculated. In an example embodiment, the interpolated beat frequency fb_i can be calculated using the following formula.

$$fb\_i = ( \# of highest data point \times Δ x + \frac{ap - an}{2 a 0 - an - ap} \times Δ x - \frac{Δ x}{2} )$$

FIG. 4 illustrates the frequencies an, ao, and ap, where ao is the amplitude of the highest frequency in the oversampling FFT result, an and ap are the amplitudes of the adjacent frequencies. As is clear above, the amplitude is needed to determine the most accurate beat frequency. Therefore, errors in amplitude introduce errors during interpolation. Thus, amplitude stability is a significant aspect to implementation of the interpolation technique.

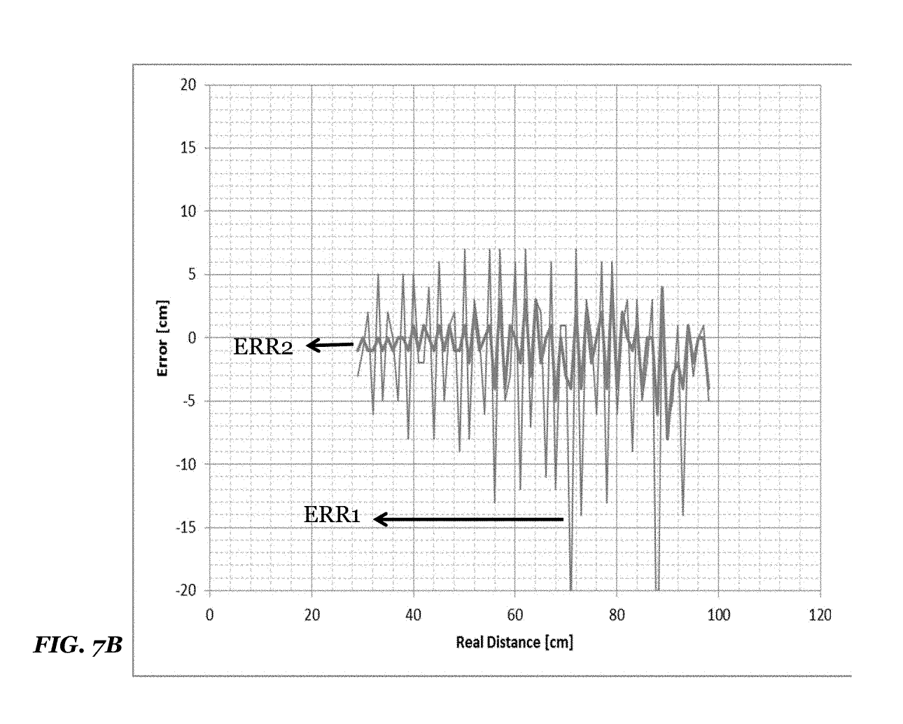

FIG. 5 shows the result of interpolation with unstable amplitude. As described previously, the inventors of this application have discovered that the variation in the amplitude of the reflected signal may introduce errors in the determination of the distance to the object.

FIG. 5 illustrates the variation in amplitude with frequency, which translates to calculated distance, for two different test cases where the objects are located at the same distance from the radar antenna. In the first case, which is marked by the first curve C1 in FIG. 5, the estimated maximum amplitude is different from the estimated maximum amplitude of the second curve C2. For example, the first and the second curves C1 and C2 may be identifying information for two objects at the same distance to the radar. For example, the first curve C1 and the second curve C2 may be due to instability in the reflected signals, which may be due to a number of reasons such as external environmental factors. One reason for the difference in amplitude may be the size of the object.

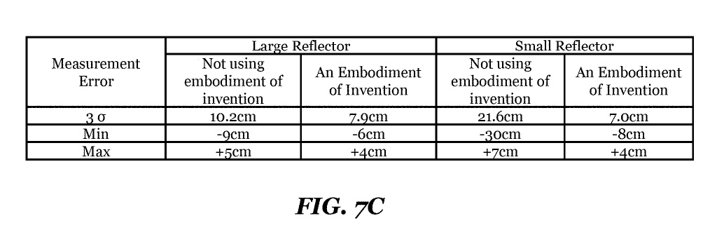

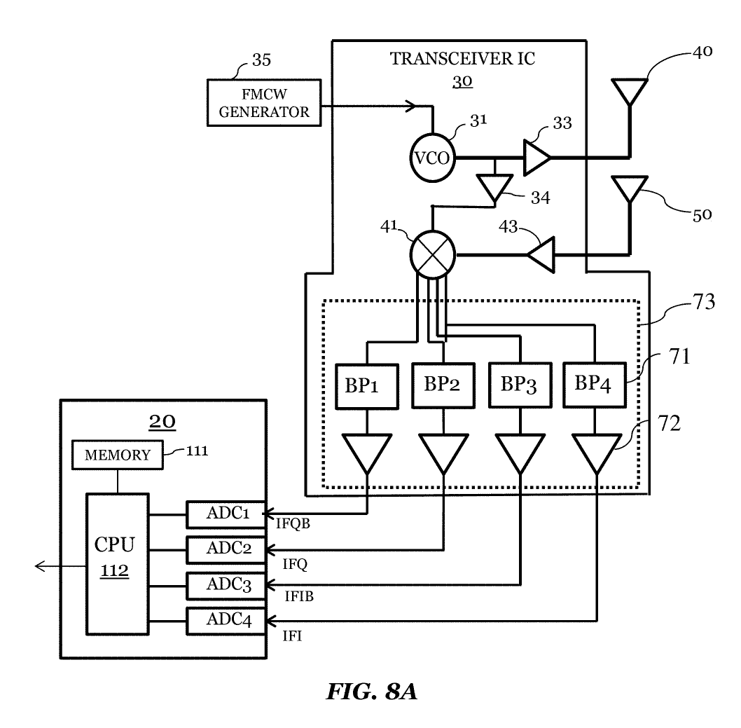

Embodiments of the present invention avoid these errors by using a four phase signals to obtain a stable amplitude. For example, FIG. 6A illustrates that the reason for the amplitude instability is due to the varying nature of the envelope IF signal amplitude when only two phases are used. When the reflected amplitude from the object is low, the instability in the IF signals' envelope introduces additional error during subsequent digital signal processing. In particular, when the reflected signal's amplitude is low, calculation of interpolation may include noise floor power, and thus the error of interpolation will likely be bigger than when the reflected amplitude is higher. In contrast, as illustrated in FIG. 6B, the four phase signal shows a much more stable envelope IF signal amplitude than the two phase envelope IF signal illustrated in FIG. 6A. Accordingly, the amplitude instability can be significantly reduced by using the four phase signals.

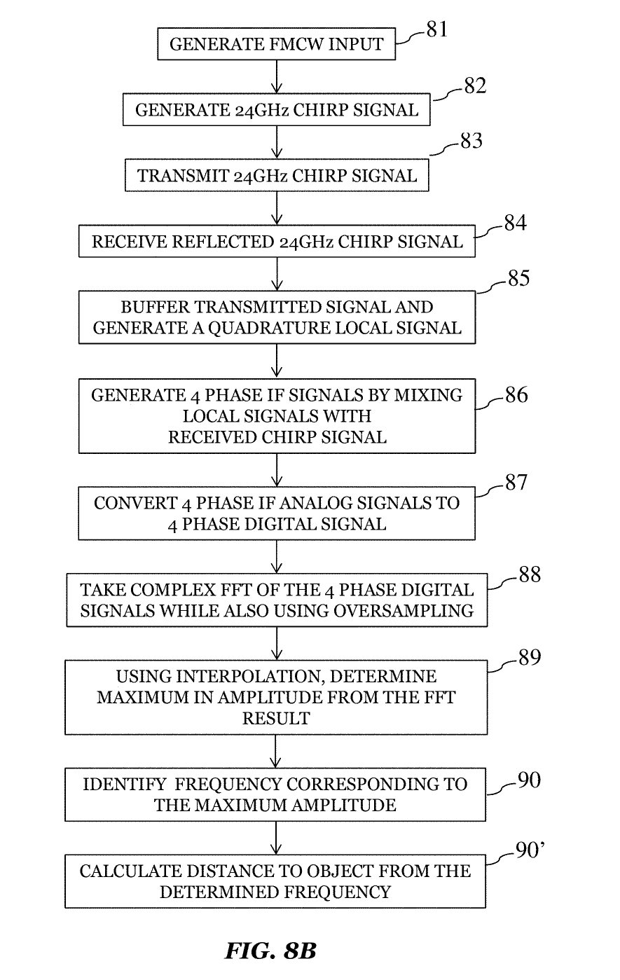

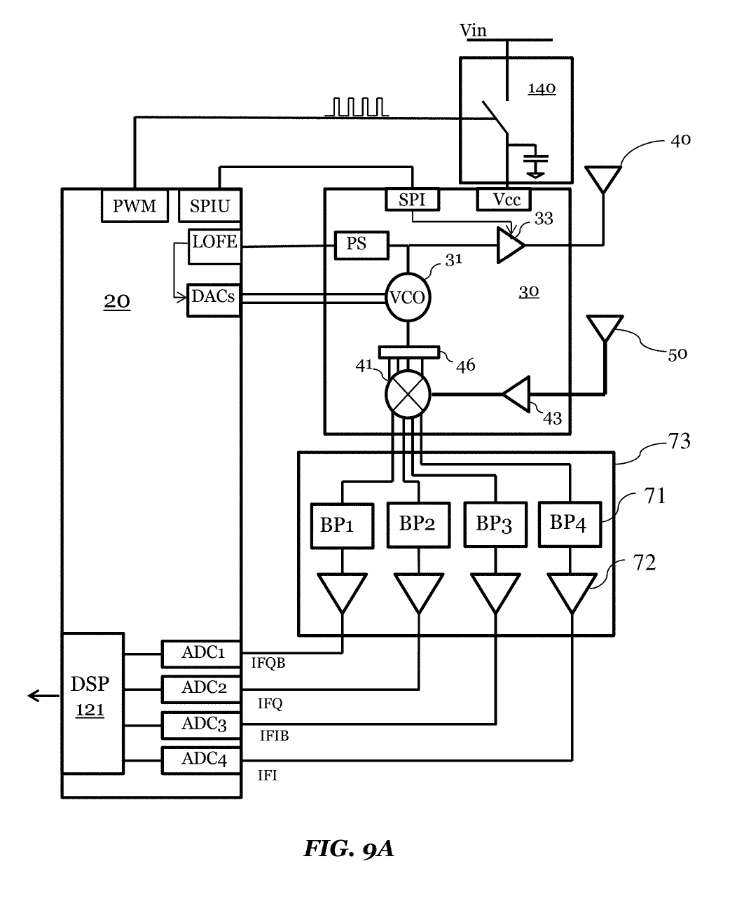

FIG. 7A illustrates the real distance to an object with measurement error for a large reflecting object while FIG. 7B illustrates the real distance to an object with measurement error for a small reflecting object. The measurement error in FIGS. 7A and 7B denotes the difference between the actual distance to the object from the computed distance to the object using the radar system. FIG. 7C is a table summarizing the results for the large and small reflectors as an example.

In FIGS. 7A and 7B, the curves error 1 (ERR1) shows the result without using embodiment of the present invention while the curves error 2 (ERR2) shows the result obtained including the embodiments of the present invention for a 24 GHz radar system. As is evident, (also from FIG. 7C), the measurement error in distance measurement is significantly less than 10 cm, and around 5 cm.

As is evident, using the four phase IF signal in combination with the oversampling and interpolation provides the best accuracy for both smaller objects and larger objects. In fact, this is better than using only oversampling and interpolation. In particular, as expected, the difference is more evident for smaller objects, which have a lower reflected amplitude.

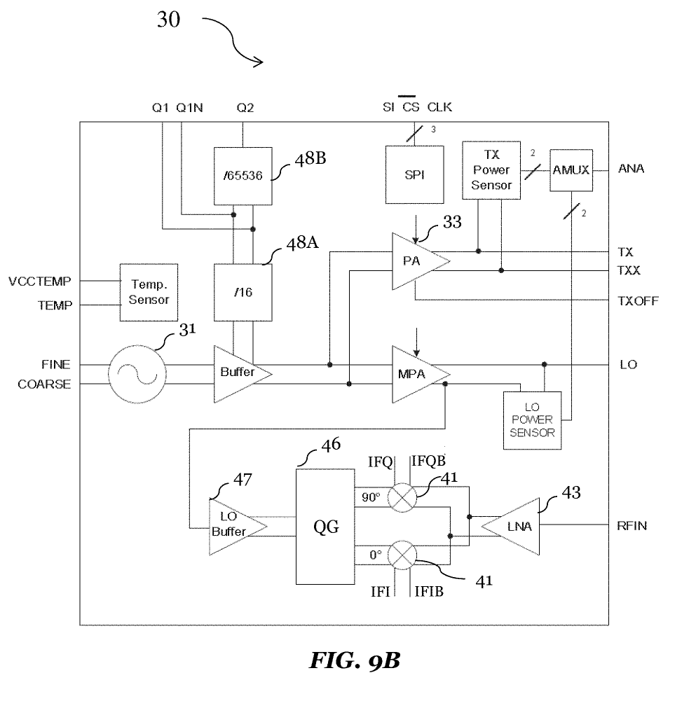

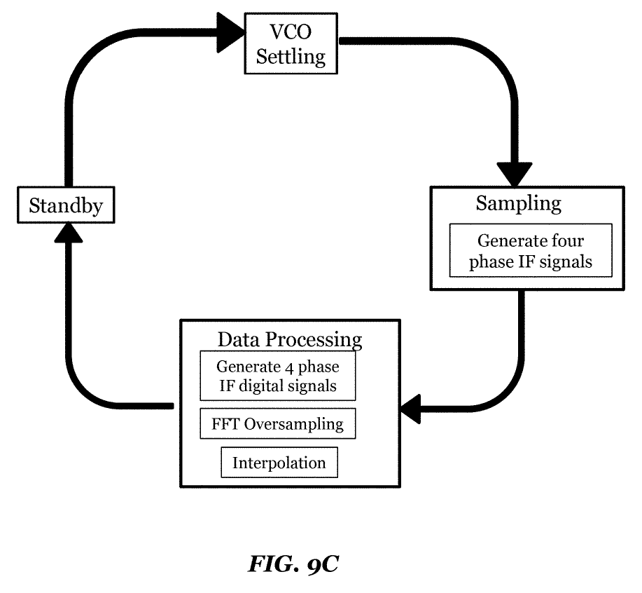

FIG. 8A is a radar system illustrating a hardware implementation of the embodiment of the present invention. FIG. 8B illustrates corresponding schematic steps in the use of the radar system.

Referring to FIG. 8A, the radar system includes a transceiver IC 30 and a controller 20 coupled to the transceiver IC 30. A transmit antenna 40 and a receive antenna 50 are coupled to the transceiver IC 30. A frequency modulator continuous wave (FMCW) generator 35 provides a FMCW input to the VCO 31 (box 81). The FMCW generator 35 generates a voltage to modulate the VCO frequency and may comprise DA converter or a phase locked loop (PLL) in different embodiments.

The voltage controlled oscillator (VCO) 31 generates a 24 GHz (or other radar frequencies) chirp signal, which is transmitted through the transmit antenna 40 after appropriate power amplification at the power amplifier 33 (boxes 82-83). The received signal is received at the receive antenna 50 and amplified at a low noise amplifier 43 (box 84). The transmitted signal from the VCO 31 is buffered at the buffer amplifier 34 and provided to the mixer 41, which also receives the received signal from the receive antenna 50 (box 85).

The mixer generates a four phased quadrature intermediate frequency (analog) signal comprising intermediate frequency (IF) signals having phase differences of 0°, 90°, 180°, and 270° (box 86). The IF signals are filtered through a baseband module 73 including a band pass filter or high pass filter (BP1, BP2, BP3, and BP4) 71 and amplified in a low noise amplifiers 72.

The analog signals are converted into digital signal either within the transceiver IC 30, within the controller 20, or in separate ADC units in various embodiments (box 87). Accordingly, four digital intermediate frequency signals are generated. The digital outputs from the analog to digital converters (ADCs) are provided to a processor (CPU) 112, which may be a digital signal processor in various embodiments. The controller 20 may include a memory 111 for storing data related to the digital signal processing. For example, the algorithms for the interpolation and oversampling may be stored in the memory 111.

A complex FFT (CFFT(I-IB, Q-QB)) of the previously generated digital IF signals is performed while also using oversampling/zero padding (box 88). In other words, a complex number is generated, which comprises the differential signal I-IB as the real part and the differential signal Q-QB as the imaginary part. The FFT of this complex number is then performed. The highest amplitude data points from the complex Fourier transform (CFFT) are selected. For example, in one embodiment, three of the highest amplitude data points are selected. Using an interpolation technique, the maximum in amplitude is found, e.g., interpolating between the three or four highest points (box 89). In various embodiments, any appropriate method for calculation of the maximum may be used. The frequency corresponding to the maximum in amplitude is the beat frequency (box 90). The distance to the object is calculated using this computed beat frequency (box 90′).

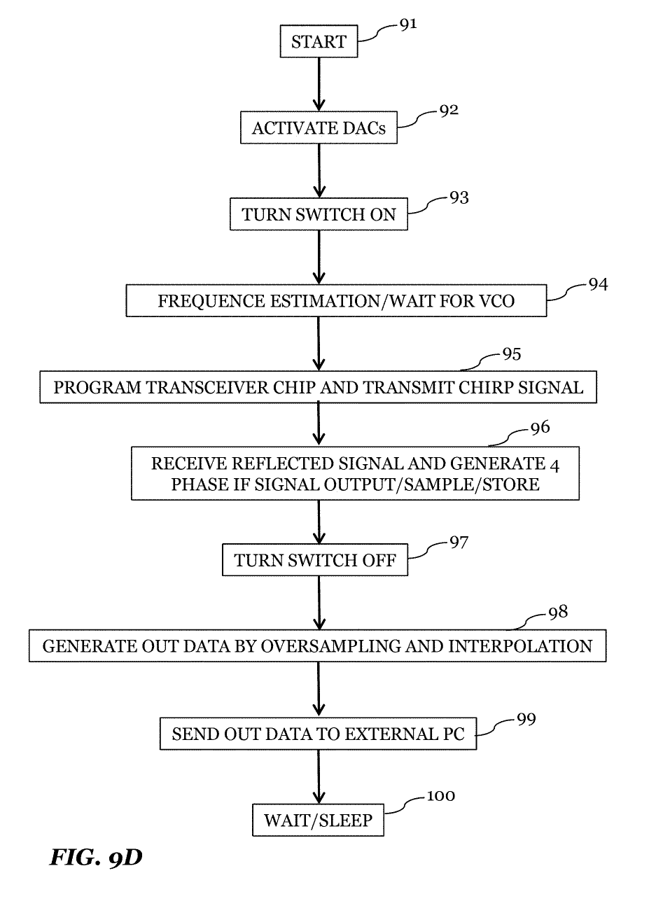

FIGS. 9A-9D illustrate an alternative hardware implementation of the embodiment of the present invention. FIG. 9A illustrates a system schematic, FIG. 9B illustrates a magnified schematic of the radar IC, FIG. 9B illustrates an operation cycle of the radar system, and FIG. 9D illustrates operational steps of the radar system.

The radar system consists of the radar IC (transceiver IC 30), a baseband module 73, a controller 20, and a load switch 140 connected to the power supply input of the radar IC. The transceiver IC 30 may be similar and include similar components as the transceiver IC described in earlier embodiments and are therefore not repeated.

The SPI interface is used to program the registers of the radar IC 30. For example, the output power setting, enable PA, multiplexer settings, and other aspects of the transceiver IC 30 may be programmed. The controller 20 also controls a load switch 140 to connect or disconnect the transceiver IC 30 to and from the supply voltage. The controller 20 may also monitor the temperature of the transceiver IC 30. The controller may also behave as a master where the Digital-to-Analog converters (DACs) are connected through low-pass RC filters to the coarse and fine inputs of the VCO 31.

The VCO 31 may be a free running, fundamental oscillator. The VCO 31 may be controlled by two tuning inputs, one for coarse pre-adjustment and one for fine-tuning. Depending on the prescalers that are available (e.g., FIG. 9B illustrates two prescalers 48A and 48B), the VCO may be controlled externally, e.g., through a RF-PLL or through the controller 20 using a software control loop.

The VCO's (voltage controlled oscillator) 31 tuning voltages are controlled directly by the DACs (Digital-to-analog converter) of the controller 20 in one embodiment. The controller 20 estimates the VCO frequency using a lower frequency (e.g., 23 kHz) digital prescaler output. The prescaler PS (FIG. 9A) scales the output signal from the VCO and provides it to the LO frequency estimation unit LOFE (FIG. 9A) of the controller 20. The frequency estimation may be implemented through counting the rising and falling edges over a time interval. The result is then compared to a reference clock signal at the controller 20 that is generated using a precise crystal oscillator.

As best viewed in FIG. 9B, a quadrature generator 46 is coupled to the output signal from the VCO 31 to obtain the local (LO) signals. In one embodiment, a RC polyphase filter may be used for LO quadrature phase generation. The quadrature generator 46 has four output local signals with different phases. In particular, the quadrature generator 46 generates two differential signals that are phase separated, i.e., a 0° and 90° phase differential signals. As each differential has two signals separated by 180°, the output from the quadrature generator 46 comprises a 0°/180° differential signal and a 90°/270° differential signal. The quadrature generator 46 drives the mixers 41 with local signals that have a 90 degree phase shift between each other. The output signal from the VCO 31, which may be isolated by a buffer amplifier 47, is sampled through a quadrature generator 46 and mixed with the RF inputs provided by the low noise amplifier 43 to generate the IF signals (IFI, IFIB, IFQ, and IFQB) that are each separated in phase by 90°. In particular, the RF signal received from the receiving antenna is a differential signal and the LO signal from the quadrature generator 46 is quadrature signal. The quadrature IF signals are thus generated from the differential RF signal and quadrature LO signals.

The mixers 41 generate the four phase components of the intermediate frequency signal by combining the transmitted signal from the VCO 31 and the received signal from the receiver end low noise amplifier 43. The mixer 41 may comprise a quadrature downconversion mixer or a zero-IF mixer that directly translates the RF signal to an intermediate frequency signal. In one embodiment, the mixers 41 comprise homodyne quadrature downconversion mixers. In various embodiments, the mixers 41 convert 24 GHz signals at the low noise amplifier 43 directly down to zero-IF and generate four differential in-phase and quadrature IF output signals (0°, 90°, 180°, and 270°).

A baseband module 73 is used to amplify the baseband Doppler (intermediate frequency) signals so that it matches the ADC input range and to filter the frequency equivalents of unwanted velocities. All the four phase components of the intermediate frequency signal are separately amplified and filtered at the baseband module 73 using the bandpass filters BP1, BP2, BP3, and BP4 along with the low noise amplifiers 72.

The subsequent process steps showing only operations related to the computation of the distance is shown in FIG. 8B and explained above and are therefore not repeated again.

FIG. 9C illustrates a duty cycle operation of the radar system in accordance with embodiments of the present invention. The operation of the radar system may be implemented as shown in FIG. 9C in one embodiment. The radar system may be in one of the four modes of operation including: standby mode, VCO settling mode, sampling mode, and data processing mode. Some of the operations especially when performed by different components may be performed in parallel.

Of course the radar system is in standby mode when not operational. After a certain time in standby mode the controller 20 is woken up by a timer interrupt and turns on the transceiver IC 30. During VCO settling mode, the output from the power amplifier 33 is kept disabled until the VCO frequency is inside the allowed ISM band (e.g., 24.05 GHz-24.25 GHz in Japan) for transmission. After that, the transmission of the signal is enabled and the received and down-converted signal is sampled. Once the VCO frequency is within the ISM band, the power amplifier 33 may be enabled and the generated baseband signal is sampled by the plurality of analog-to-digital converters (ADC1, ADC2, ADC3, and ADC4). After sampling, the data generated is processed at the controller 20. The main blocks of the processing of the four phased IF signals include performing a complex FFT (Fast Fourier Transform) using the oversampling followed by interpolation techniques described earlier and a determination of the beat frequency corresponding to the maximum amplitude. In particular, a complex FFT (CFFT(I-IB, Q-QB)) of the previously generated digital IF signals is performed while using oversampling/zero padding. In other words, a complex number is generated by subtracting the signal I from the signal IB to get the real part and subtracting the signal Q from the signal QB to get the imaginary part (noting that signals I and IB are offset by 180° while Q and QB are offset by 180°. The subtraction of the signal I from the signal IB creates a I differential signal and the subtraction of the signal Q from the signal QB creates a Q differential signal. The FFT of this complex signal is then performed. The highest amplitude data points from the complex Fourier transform (CFFT) are selected. For example, in one embodiment, three of the highest amplitude data points are selected. Using an interpolation technique, the maximum in amplitude is found, e.g., interpolating between the three or four highest points. In various embodiments, any appropriate method for calculation of the maxima may be used. The frequency corresponding to the maximum in amplitude is the beat frequency. The distance to the object is calculated using this computed beat frequency.

A detailed description of the process steps during the radar operation is described using FIG. 9D. After the start (box 91) of the radar system, the DACs are activated (box 92) so as to trigger the VCO to fire. Then, analog front-end of the radar IC 30 turns on (box 93). The system waits for the VCO frequency to settle within the ISM band (box 94). The power amplifier 33 may then be activated through the SPI bus using SPIU and SPI (95). At this point, optionally, other operations of the transceiver IC 30 may be programmed. The received signal is processed at the mixers 41 to generate four phase IF signals that are optionally stored in a memory of the controller 20 (box 96). The transceiver IC 30 may be deactivated if needed to save power (box 97).

The DSP unit 121 (see FIG. 9A) processes the digital data stored in the memory of the controller 20 using FFT oversampling or zero padding combined with interpolation techniques described earlier to identify the frequency with the highest amplitude, which is then used to compute the distance to the object (box 98). Optionally, the data processed from the FFT is sent to an external PC or radar applied unit (box 99). The system goes to back to sleep mode or wait mode (box 100). A more detailed process flow of the operations of the radar system showing only operations related to the computation of the distance is shown in FIG. 8B.

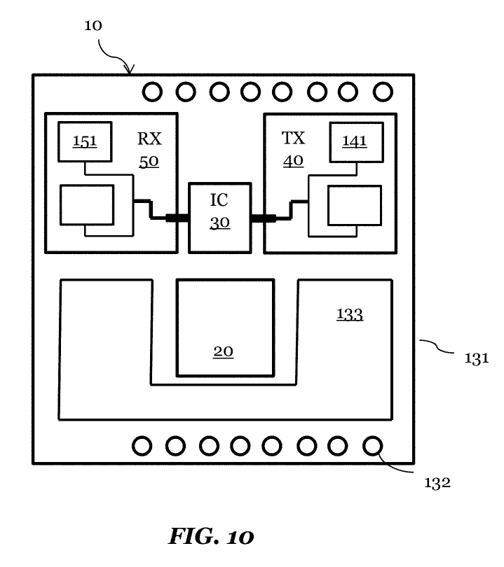

FIG. 10 illustrates a top sectional view of just a packaged radar IC with an integrated antenna.

Referring to FIG. 10, the radar system as described in various embodiments may be implemented using a transceiver IC 30, e.g., as described previously. The transceiver IC 30 and the controller 20, e.g., as described previously may be assembled on a circuit board 131. The controller 20 may include ADC as wells as the DSP core and the functions already described previously.

In one embodiment, the transceiver IC 30 may be a near chip-scale plastic encapsulated package, for example, the transceiver IC 30 is a thin encapsulated package such as a Very Thin Profile Quad Flat Non Leaded (VQFN) package. The bottom of the transceiver IC 30 has a die pad that is soldered directly with a pad on the circuit board 131. Similarly, the bottom of the package also has a plurality of pads around the die paddle that are also soldered to pads on the circuit board 131. In one embodiment, the controller 20 may be packaged as a low profile plastic encapsulated leadframe package having an exposed die pad and leads which are soldered to pads on the circuit board 131.

In one embodiment, referring now to FIG. 10, the antennas may be integrated on the circuit board 131. In other embodiments, the antennas may also be assembled together with the transceiver IC 30.

The transmit front end circuit within the transceiver IC 30 is coupled to the transmit patch antenna 141 while the receiver front end circuit within the transceiver IC 30 is coupled to the receive patch antenna 151. The transmit patch antenna 141 and the receive patch antenna 151 may be located on opposite sides and isolated from each other.

The circuit board 131 includes input/output pins 132 and may also have other components 133.

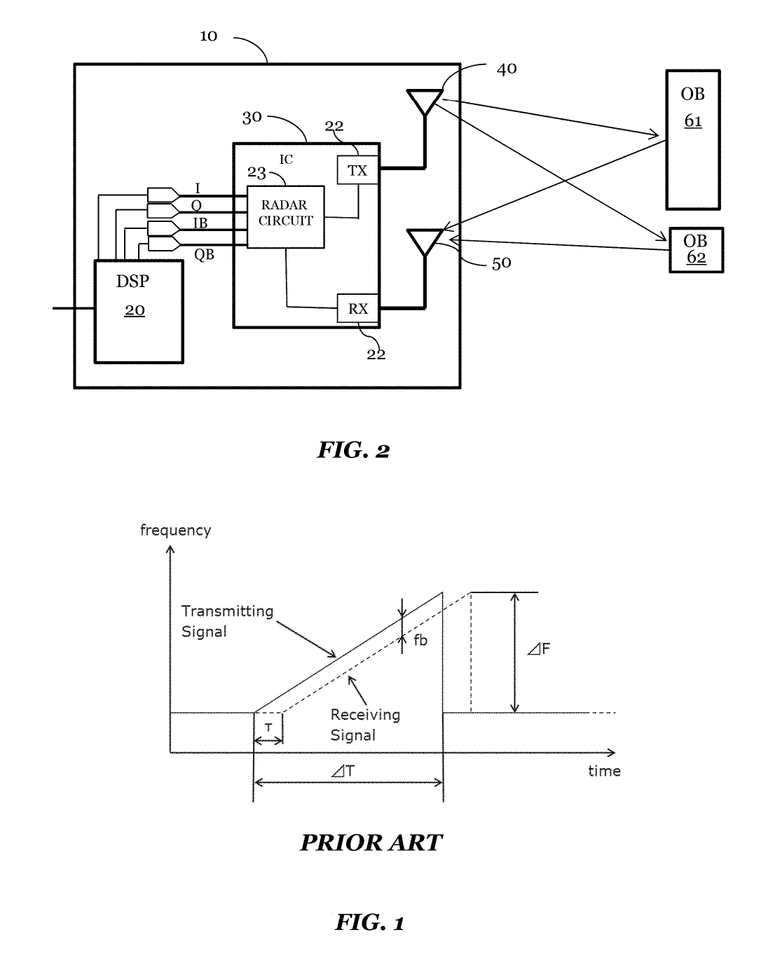

While this invention has been described with reference to illustrative embodiments, this description is not intended to be construed in a limiting sense. Various modifications and combinations of the illustrative embodiments, such as combining FIGS. 1-10, as well as other embodiments of the invention, will be apparent to persons skilled in the art upon reference to the description. It is therefore intended that the appended claims encompass any such modifications or embodiments.

What is claimed is:

1. A radar system comprising:
a radar transceiver device comprising:
a transmitter front end circuit for transmitting a chirp signal towards an object,
a receiver front end circuit for receiving the reflected chirp signal from the object,
a Voltage Controlled Oscillator (VCO) to generate a transmitted chirp signal, and
a mixer configured to generate four intermediate frequency output signals having different phases; and
a controller device comprising:
a processor, and
a memory for storing the intermediate frequency output signals and instructions for executing in the processor, wherein the instructions cause the processor to
generate a complex Fast Fourier Transform (FFT) result by performing a FFT of the intermediate frequency output signals while using zero-padding,
using interpolation, determine a maximum amplitude in the FFT result and identifying the frequency corresponding to the maximum amplitude, and
calculate a distance to the object using the determined frequency.

2. The radar system of claim 1, wherein the transmitter front end circuit comprises a power amplifier.

3. The radar system of claim 1, wherein the receiver front end circuit comprises a low noise amplifier.

4. The radar system of claim 1, wherein the voltage controlled oscillator is accompanied by a quadrature generator configured to produce a plurality of phase shifted signals.

5. The radar system of claim 1, wherein the mixer is accompanied by a quadrature generator configured to produce a plurality of phase shifted signals.

6. The radar system of claim 1, further comprising four analog to digital converters for converting each of the four intermediate frequency output signals into a corresponding digital signal.

7. The radar system of claim 6, further comprising a base band amplifier and band pass filter to filter the four intermediate frequency output signals and amplifying the filtered four intermediate frequency output signals before the converting.

8. The radar system of claim 1, further comprising:
a first patch antenna coupled to the transmitter front end circuit; and
a second patch antenna coupled to the receiver front end circuit.

9. The radar system of claim 1, further comprising:
a plurality of patch antennas coupled to either the transmitter or the receiver front end circuit, or both the transmitter and the receiver front end circuit.

10. The radar system of claim 1, wherein the chirp signal is utilizing Industrial, Science, and Medical (ISM) band.

11. The radar system of claim 1, wherein the radar system is configured to operate between 24.00 GHz to 24.25 GHz.

12. A method of estimating of a distance to an object using a radar system, the method comprising:
generating chirp signals at an oscillator
from a transmit antenna, transmitting a chirp signal towards an object;
from a receiving antenna, receiving the reflected chirp signal from the object;
generating a plurality of phase shifted reference signals from the transmitted chirp signal;
mixing the plurality of phase shifted reference signals with the received reflected chirp signal to generate four intermediate frequency output signals having different phases;
storing the intermediate frequency output signals in a memory;
generating a complex Fast Fourier Transform (FFT) result by performing a FFT on the intermediate frequency output signals while using zero-padding,
using interpolation, determining a maximum amplitude in the FFT result and identifying the frequency corresponding to the maximum amplitude; and
calculating a distance to the object using the determined frequency.

13. The method of claim 12, wherein the chirp signal is generated at a voltage controlled oscillator.

14. The method of claim 13, wherein the signal generated at the voltage controlled oscillator is amplified at a power amplifier before the transmitting.

15. The method of claim 12, wherein the received reflect chirp signal at the receive antenna is amplified at a low noise amplifier before the mixing.

16. The method of claim 12, further comprising converting each of the four intermediate frequency output signals into a corresponding digital signal.

17. The method of claim 16, further comprising
filtering, each of the four intermediate frequency output signals generated by the mixing, at bandpass filter; and
amplifying the filtered four intermediate frequency output signals.

18. The method of claim 12, wherein the transmit antenna comprises a first patch antenna, and wherein the receive antenna comprises a second patch antenna.

19. The method of claim 12, wherein the transmit and/or receive antenna comprises a plurality patch antennas.

20. The method of claim 12, wherein the chirp signal is utilizing Industrial, Science, and Medical (ISM) band.

21. The method of claim 12, wherein the radar system is configured to operate between 24.00 GHz to 24.25 GHz.
